(19) United States
(12) Patent Application Publication
(10) Pub. No.: US 2008/0179040 A1
(43) Pub. Date: Jul. 31, 2008

(54) METHOD TO HEAT OR COOL VEHICLE BATTERY AND PASSENGER COMPARTMENTS

(76) Inventor: Richard W. Rosenbaum, Bloomfield Hills, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/627,553

(22) Filed: Jan. 26, 2007

(51) Int. Cl. F25B 29/00; F24J 2/00; H05B 1/00; H02J 7/00

(52) U.S. Cl. 165/61; 126/569; 219/209; 320/137

(57) ABSTRACT

A battery heater/cooler increases mileage, comfort and/or safety in a conventional, electric or hybrid electric vehicle. An enclosure around the battery or batteries includes an inlet for heated or cooled air or liquid and an outlet to facilitate the transfer of heated or cooled air into a passenger compartment. A second battery unit may be used in conjunction with a timer or a remote controlled device to pre-heat or pre-cool itself and the primary battery or batteries and/or passenger compartment before commute times.

### FIELD OF THE INVENTION

This invention relates to passenger vehicles in general, and electric and hybrid vehicles in particular. More specifically the invention concerns apparatus and methods to heat and/or cool the battery area or compartment for greater battery efficiency, increase vehicle fuel mileage, and pre-warm or pre-cool the passenger compartment to increase driver safety and comfort.

### BACKGROUND OF THE INVENTION

A confluence of improved battery technology, rising fuel costs and greater environmental awareness, has caused electric and hybrid vehicles to become increasingly popular.

The efficiency of any battery or battery pack, and also the fullness of its charging, are functions of ambient temperature. A battery can be charged more fully within a specific tepid temperature range.

The number of city miles per gallon in a typical hybrid car may vary from the low 40s to the mid 50s over a temperature range of −10° F. to 70° F. This range is smaller for highway driving, but nevertheless it is significant.

In purely electric vehicles, both the extent of the battery charge and the subsequent driving range are related to ambient temperatures. Elevated temperatures limit full battery charging. Temperatures below freezing, and especially those below OF zero, result in a drastically reduced driving range following a full battery charge.

Also, a driver in an uncomfortably cold or hot vehicle responds and reacts less quickly and is a less safe driver. A driver in a vehicle with a temperature in the comfort zone is a much safer driver.

Pre-cooling of battery and/or passenger compartments is desirable in normal summer weather, and may be especially useful in equatorial areas, or in states such as Arizona, where day and night time temperatures during certain months are continuously and uncomfortably high.

Pre-heating of battery and/or passenger compartments is desirable whenever low ambient temperatures are uncomfortable. In addition, pre-heating of a cold battery area or compartment may result in a more efficient battery.

### SUMMARY OF THE INVENTION

This invention assists with better fuel economy, a longer driving range, and safer vehicle operation, by providing apparatus and methods to pre-heat and/or pre-cool battery and passenger compartments. Preferably the functions of heating and cooling are combined in one unit, using a heat pump, for example, but separate units can accomplish the same objectives.

In the preferred embodiment, the apparatus is attached to a portion of a battery compartment, with a portion of the housing including an inlet for heated or cooled air, or a liquid to accomplish heating or cooling and an outlet vent to heat or cool the passenger cabin. In an alternative embodiment, at least a portion of the cover is transparent and exposed to the outside environment to facilitate solar heating or cooling either by itself or in conjunction with other heating or cooling methods.

Particularly if a forced-air source is used to heat or cool the battery or batteries, this air may then flow into the interior of a car to pre-heat or pre-cool the passenger compartment. A separate battery or series of batteries may be included according to the invention to facilitate this climate control, and this separate battery power source may be used in conjunction with a timer or a remote-control device, to pre-heat or pre-cool the battery or batteries and/or the passenger compartment for the morning and/or afternoon commute times. Thus, when the electric or hybrid vehicle reaches a destination, such as the workplace, the preferably separate battery or batteries, having also been charged the previous night, and further charged during the morning commute, may be used on a timer or remote-control basis to pre-heat or pre-cool the battery and passenger compartments prior to the evening commute, thereby increasing mileage and/or comfort in the passenger compartment.

Batteries will normally be charged electrically during evening hours. To conserve the strength of the auxiliary battery unit, the same electrical source, rather than batteries, will preferably be used to pre-warm or pre-cool the battery and passenger compartments.

While the focus of the invention is the passenger automobile, other types of land, air and sea transportation vehicles are not precluded.

### BRIEF DESCRIPTION OF THE DRAWING

FIG. 1 is a drawing which illustrates the preferred embodiment of the invention.

### DETAILED DESCRIPTION OF THE INVENTION

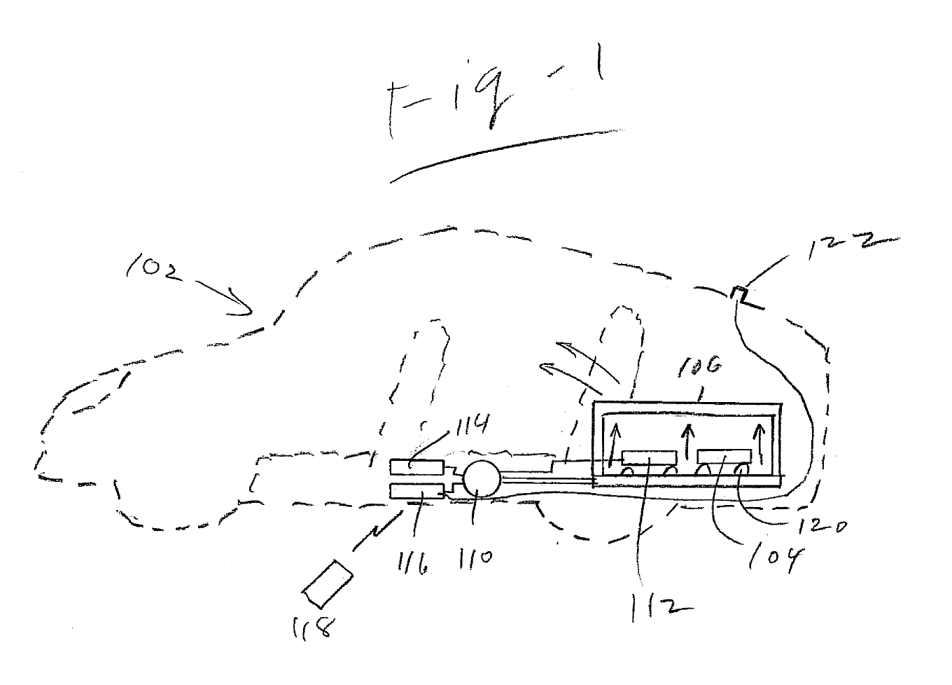

Referring to FIG. 1, the preferred embodiment of the invention is depicted within a vehicle such as 102. The vehicle 102 may have a conventional power source, or be a fully electric vehicle, or a hybrid vehicle that includes a gas or other engine (not shown) as a primary motive power source. The invention is applicable to all types of vehicles, including “plug-in” hybrid and fuel cell cars.

The propulsion battery or batteries to be warmed or cooled are shown at 104. In the preferred embodiment, the battery or batteries rest on risers 120 on the floor of enclosure 106, and a portion of the enclosure includes a manifold with apertures facilitating the circulation of heated or cooled air around the battery or batteries. The flow of heated or cooled air is shown with the arrows. In the preferred embodiment, after heating or cooling of the battery or batteries 104 with the circulated air, said heated or cooled air is released into the passenger compartment to warm or cool the interior of the car, rather than releasing it to the atmosphere. A thermostatic sensor prevents excessive heating, As an alternative to the general release of heated air into the interior of the car, such air may be directed to specific locations, such as the windshield, mirrors, door locks and so forth.

To provide the heated or cooled air while the vehicle is not connected to an electrical source, as during evening battery charging, the system utilizes the additional battery or batteries 112, preferably also within enclosure 106, which creates heated or cooled air using a pump 110, coupled to the enclosure 106 through an insulated conduit. Like the battery or batteries 104, battery unit 112 could be charged by braking, coasting and other means while the vehicle is in operation as well as electrically when stationary.

This applied heated or cooled air may be controlled in various ways according to the invention. In one preferred embodiment, timer electronics 114 may be provided, such that all of the vehicle's batteries are automatically warmed or cooled to a predetermined temperature range, preferably electrically but alternately by the auxiliary battery unit, immediately before a typical morning or late afternoon commute. The timing of this would be controlled by a user, in much the same way that a set-back thermostat is programmed. The programming interface would preferably be provided through an interface on the vehicle's dashboard. For example, the system, depending on expected ambient temperatures and type of battery system, could be set to begin heating or cooling the batteries between the hours of 7:45 to 8 A.M. and/or 4:45 to 5 P.M., for example, and could be automatically switched off when a desired temperature is reached or when the vehicle is started.

Instead of timer 114, or in conjunction with the timer 114, a remote control receiver 116 may be provided, allowing a hand-held remote 118 to begin the generation of warm or cool air. This feature may be advantageous for an uncommon commute time, or when an individual has variable commuting times, or must leave for home or work early, before the timer 114 would have otherwise been programmed to initiate activity. An indicator 122, preferably visible from outside the vehicle, will indicate the occurrence of battery charging by electricity, or vehicle warming or cooling by battery or electrically.

In the preferred embodiment, the system just described would be factory installed, since multiple interconnections would need to be provided, and the battery or batteries in 104 could be difficult to access. However, despite any difficulty with installation, the provision of an after-market application is not precluded by the invention.

I claim:

1. A heating and/or cooling system for a battery or batteries in a conventional, electric or hybrid/electric vehicle, comprising:
a unit configured to house a battery or batteries; and
a source of heated or cooled air directed into the housing.

2. The heating/cooling system of claim 1, wherein the source of heated or cooled air is a battery or electrically operated electric heater or heat pump located within the vehicle.

3. The heating/cooling system of claim 2, wherein the battery system used to operate the heater or heat pump is separate from the other battery or batteries also being heated or cooled.

4. The heating/cooling system of claim 2, wherein the battery or batteries used to operate the heater or heat pump are recharged when the vehicle is in operation.

5. The heating/cooling system of claim 2, wherein the battery or batteries used to power the vehicle and operate the heater or heat pump are electrically recharged, as necessary, when the vehicle is stationary.

6. The heating/cooling system of claim 1, further including a timer operative to automatically activate the production of heated or cooled air at a preprogrammed time.

7. The heating/cooling system of claim 1, further including a portable remote controlled transmitter operative to activate the source of heated or cooled air from a distance.

8. The heating/cooling system of claim 1, wherein heated or cooled air from the housing is discharged into a vehicle interior.

9. The heating/cooling system of claim 1, wherein at least a portion of the housing facilitates solar heating or cooling of the battery or batteries contained therein.

10. The heating/cooling system of claim 1, further including a light or other indicator to show that the vehicle's batteries are being recharged or heated or cooled while the vehicle is stationery.

11. The heating/cooling system of claim 1, wherein the battery or batteries are elevated to promote the flow of heated or cooled air.
